(19) United States
(12) Patent Application Publication
(10) Pub. No.: US 2020/0129375 A1
(43) Pub. Date: Apr. 30, 2020

(54) METHOD AND DEVICE APPLYING ACUPRESSURE AT TARGETED FACIAL POINTS TO DILATE INTERNAL NASOPHARANX PASSAGEWAYS

(71) Applicant: James P. Viken, Eden Prairie, MN (US)

(72) Inventor: James P. Viken, Eden Prairie, MN (US)

(21) Appl. No.: 16/730,918

(22) Filed: Dec. 30, 2019

Related U.S. Application Data
(63) Continuation-in-part of application No. 15/631,632, filed on Jun. 23, 2017.
Application No. 15/631,632 is a continuation-in-part of application No. 14/070,910, filed on Nov. 4, 2013, now abandoned.
Application No. 14/070,910 is a continuation of application No. 12/945,826, filed on Nov. 12, 2010, now abandoned.
(60) Provisional application No. 61/260,682, filed on Nov. 12, 2009.

(51) Int. Cl. A61H 39/04

(52) U.S. Cl. CPC A61H 39/04; A61H 2201/1604; A61H 2205/026; A61H 2205/023; A61H 2201/14

(57) ABSTRACT

A nasal dilation device and method of use for applying an acupressure force at targeted cheek tissue to provide enhanced inhalation and exhalation via the remote relaxation and dilation of internal nasal passageways away from the targeted areas. The device may be used to enhance respiration during a variety of activities by indirect dilation of protected nasopharanx passageways. The device includes a support element coupled to the pads to maintain the pads at the targeted areas during use.

### RELATED APPLICATIONS

This application is a continuation-in-part of U.S. application Ser. No. 15/631,632, filed Jun. 23, 2017, which claimed the benefit of U.S. application Ser. No. 14/070,910, filed Nov. 4, 2013, which claimed the benefit of U.S. application Ser. No. 12/945,826, filed Nov. 12, 2010, which claimed the benefit of U.S. Provisional Application No. 61/260,682, filed Nov. 12, 2009, and each application being incorporated herein by reference.

### FIELD OF THE INVENTION

This invention generally relates to a user interface device and more particularly to a device for enhancing respiration during various user activities including rest and sleep via application of acupressure forces at facial acupressure points.

### BACKGROUND OF THE INVENTION

The prior art has numerous devices and methods to enhance breathing through the nasal passages or address jaw pain. Among these are adhesive nasal strips applied to the outside surface of the nose hold open the nostrils to improve breathing, such as described in U.S. Pat. No. 5,533,499, entitled Nasal Dilator; U.S. Pat. No. 7,255,108, entitled An Apparatus for Inhibiting or Preventing the Clenching Action of the Jaw; and U.S. Pat. No. 4,774,935, entitled A Post Surgery Device.

### SUMMARY OF THE INVENTION

The nasal dilation device of the present invention produces a relaxation and dilation effect at internal (normally inaccessible) nasal passages, particularly the nasopharanx passageways, by application of a remote external force to a readily accessible facial acupressure site with preferably substantially no external forces being directly applied to the user's zygomatic bone or mandible by the nasal dilation device. The user's mandible is preferably maintained in its normal resting position while the internal nasal passageways at the nasopharynx are relaxed and dilated. The device apples a pre-designated acupressure force to a target area 40 (FIG. 2) located between the mandible and zygomatic bone of the user depicted. The applicant has discovered that this acupressure force at the facial target area counterintuitively and remotely relaxes and dilates the internal nasopharanx nasal passages of the user. More particularly, the applicant discovered the counterintuitive relationship between an inwardly directed acupressure force applied at a Target Area 40 (between the user's zygomatic bone and mandible) and the effect of remote relaxation and dilation of the internal nasal passageways, particularly the protected nasopharynx passageways. The applicant thus discovered that Target Area 40 is a neurologically activatable pressure point that has a remote effect on the internal nasal passage where it meets the nasopharynx when adequate a focused force is applied to the Target Area. If force is applied bilaterally to the designated target areas on each side of the user's face, both sides of the internal nasal passages at the nasopharynx are relaxed and dilated thus enhancing breathing through the nose. The effects of applying a force to the specific target area on each side of the face remotely relaxes and dilates the inaccessible, internal nasal passages of the nasopharynx. The inventor also discovered that application of this inwardly directed force at the specific targeted area could be enhanced by providing an upward force (at a slight angle from the horizontal) in addition to the inwardly directed acupressure force.

This nasal dilation device enhances nasal breathing while at rest, while sleeping, during exercise, or during pursuit of individual or team sports, or anytime.

The small pad of the nasal dilation device provided in a specified range of sizes is used, although other sizes can be used that are increased or decreased without departing from the art. This pad is pressed and held in place against the upper cheek at the specific target area with sufficient force, on one side or both sides, bilaterally, with a force in the range specified. This force is applied to the target area in order to move the cheek inward to make contact with the upper rear teeth and upper rear gums with enough force to remotely relax and dilate the internal nasopharynx, but not with so much force to abrade, bruise or harm the upper rear teeth or upper rear gums. As the nasopharynx is located behind the nasal fossa inside the occipital bones, it remains open even when surrounding muscles flex so a person can continue to carry on respiratory functions. As a result, in the present invention application of the pad force at the target area 40 does not compress or occlude the nasopharynx.

The use of the nasal relaxation and dilation device of the present invention can prove useful by enhancing inhalation or exhalation by increasing airflow through the nasopharynx at each side where the force is applied to the specified target area to relax and dilate the nasopharynx at that side where the nasal cavity is connected to it and beyond into the nasopharynx itself.

A nasal dilation device in the embodiment of the present invention offers a means of enhancing nasal breathing, including inhalation and exhalation by relaxing and dilating the nasopharynx. Specific embodiments of the invention can be used to enhance respiration in many diverse applications, including while recreating or while using a medically prescribed Positive Airway Pressure type device. Other useful applications in medicine, leisure and industry will become apparent as this device gains use.

An object of the device is to enhance nasal breathing, including inhalation and exhalation, such that it requires less effort, by relaxing and dilating the internal nasopharynx passages at and inside the nasopharynx. Another object is to enable a user to enhance breathing during any physical exercise or sporting event.

Other purposes will appear in the ensuing specification, drawings and claims. The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1 is a side elevational view of an embodiment of a nasal dilation device of the present invention.

FIG. 2 illustrates a target area for positioning of the device of FIG. 1

FIG. 3 depicts a cross-section of a human head and describes various anatomical structures.

FIG. 4 is a side view of the device of FIG. 1.

FIG. 5 is a side elevational view of a second embodiment of a device of the present invention.

FIG. 6 is a side elevational view of a spring and pad portion of the embodiment of FIG. 5.

FIG. 7 is a side elevational view of a third embodiment of a device.

FIG. 8 is a spring and pad portion of the embodiment of FIG. 7.

FIG. 9 illustrates a side elevational view of a fourth embodiment of a nasal dilation device of the present invention.

FIG. 10 is a side elevational view of a fifth embodiment of a nasal dilation device of the present invention.

FIG. 11 is a spring and pad portion of the embodiment of FIG. 10.

### DETAILED DESCRIPTION OF THE INVENTION

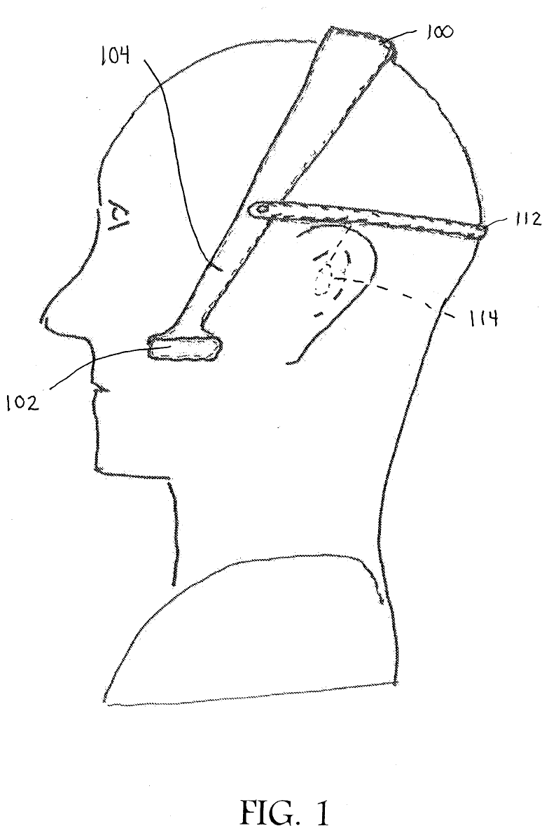

FIG. 1 depicts an embodiment of the invention in a free standing form as nasal dilation device 100. Nasal dilation device 100 is a free-standing unit including a generally C-shaped spring metal element 104 for support and placement of a pair of pads 102 upon a user. A head strap 112, is affixed to spring 104. In the illustrated embodiment, head strap 112 is an elastic band and a knob 110 on each side of spring 104 is used to retaining ends of the elastic band 112.

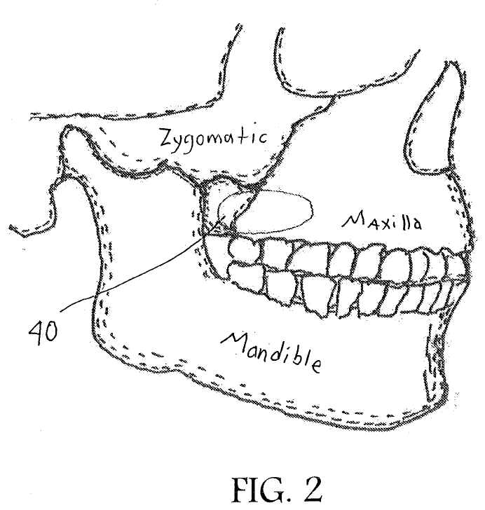

Referring to FIG. 2, the target area is defined as region 40, generally that part of the cheek where the lower lateral pterygoid process bone intersects with a maxilla bone and a zygomatic bone (also called the zygomatic arch or cheek bone). The target area 40 is preferably centered between the zygomatic bone and the upper teeth. The infratemporal surface of the maxilla is contained in the target area 40. The posterior superior alveolar nerves cross through the target area 40. The nasal dilation devices of the present invention preferably provide a force of between about 0.5 lbs-f to 3 lbs-f to the target areas 40 on each side of the user's head. Forces in the range of about 0.05-1.5 lbs-f are delivered to the target areas 1 via various pads of nasal dilation devices of the present invention. These external forces applied to the target area 40 collapse the check tissue against the teeth surfaces of the user and counterintuitively dilate nasal passageways away from the target area 40, particularly the nasopharanx passageways. Preferably, substantially none or minimal external force is directly applied by the nasal dilation device to the zygomatic bone or mandible of the user. While minimal inwardly directed forces may be applied against the lower teeth, in a preferred embodiment of the present invention substantially no external force is applied toward moving the mandible forward or rearward. The nasal dilation assembly 100 provides a force at the target area 40 to dilate nasal passageways at the nasopharanx while the mandible remains in its normal resting position.

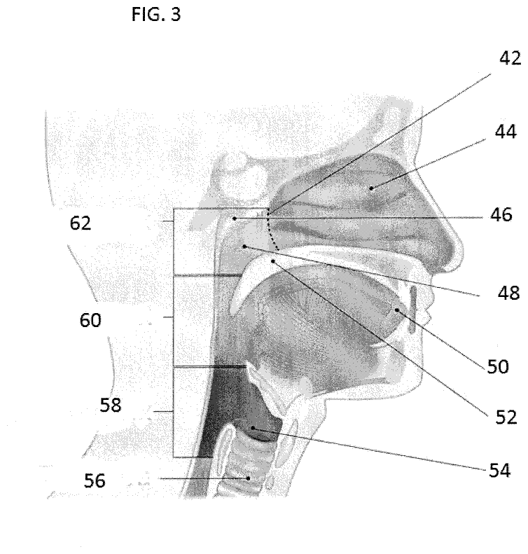

FIG. 3 depicts internal structures of a human head including internal nares 42, nasal cavity 44, adenoids (pharyngeal tonsils) 46, Eustachian tube openings 48, oral cavity 50, soft palate 52, larynx 54, trachea 56, laryngopharynx 58, oropharynx 60 and nasopharynx 62. The nasopharynx passageway 58 is situated behind, and protected by, the nasal fossa inside the occipital bone. The nasopharynx passageway 58 contains the space above the soft palate at the back of the nose and connects the nose to the mouth, which allows a person to breathe through the nose. The nasopharynx 58 is protected by nasal fossa (bone) and remains open even when surrounding muscles flex so that the person can continue to carry on respiratory functions. Similarly, external forces applied to the jaw or other facial tissue, etc. do not collapse the protected nasopharynx passageway 58.

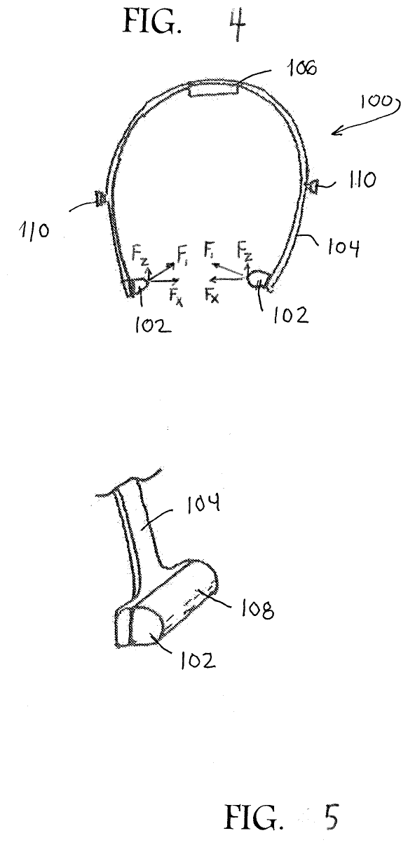

As shown in FIG. 4, a top pad 106 is affixed to spring 104 for user comfort and positioning. Pad 106 is compressible with rebound memory and suitable to convey an upward force and/or inward force to pads 102. Different thicknesses of pad 106 and different rates of compressibility can be used in order to provide different levels of pressure to the target area 40 while nasal dilation assembly 100 is properly arranged and positioned on a user.

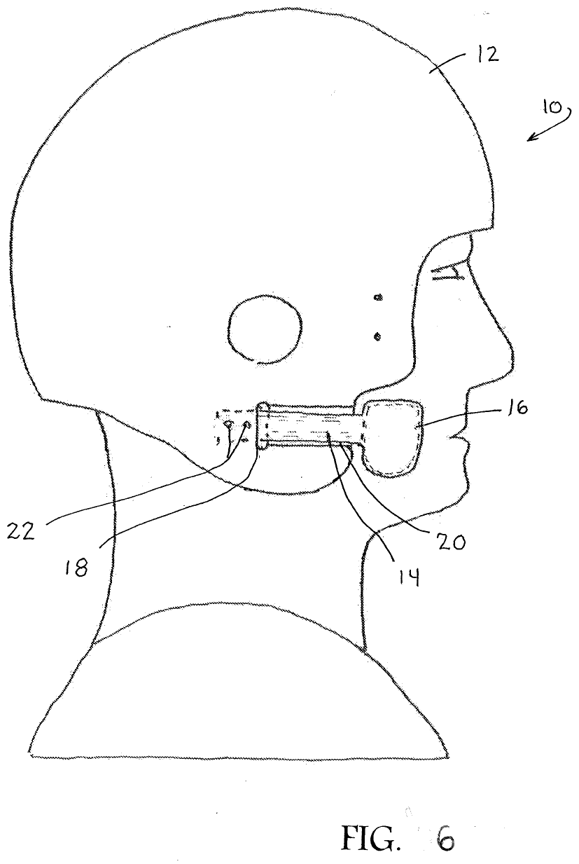

As shown in FIG. 5, in this embodiment pad 102 has a pad surface 108 which is convex in the following size: 1.25 inch long on the horizontal; 0.875 inch wide on the vertical; and 0.5 inch deep towards the users target area of contact with the inward contact area curved inward as depicted with no sharp edges. Pad which varies in size and shape can be used without departing from this novel art, while still providing the claimed result.

Double sided medical tape (not shown) can be applied to the convex pad surface 108 to help keep pad 102 in proper position while arranged and positioned on the head of a user. This tape is available as a medical grade tape and has uses in affixing medical and hair appliances. Alternatively, medical grade glue can be applied to the convex surface of pad surface 108. In another embodiment, pad 102 can be manufactured with a surface comprised of a plastic or rubber like material which remains sticky but will not erode or transfer to the user, even after washing or using. These types of materials are available from several different manufacturers and can be used in the manufacture of pads like pad 102 to help keep nasal dilation assembly 100 in proper position during use, especially during hard physical exercise with a lot of physical movement and/or jarring.

Spring 104 can be made in several different sizes such as small, medium, large, and extra-large to accommodate different users with different sized heads, or can have telescoping adjustment means built into the lower ends of each side or anywhere on each side or at the top (not shown). Spring 104 can be a simple bent spring metal construction or may comprise a combination of metal and plastic components. In the illustrated example, spring 104 is a generally C-shaped spring metal element adapted to supply an inwardly-directed force, Fₓ, (shown as vector in FIG. 4). The inwardly-directed force is generally directed toward the head center. In other examples, spring 104 is adapted to supply both inward force, Fₓ, and an upward force, F_{z} (also shown in FIG. 4). Force, F₁, is defined as the resultant combination of Fₓ and F_{z}.

In one example, strap 112 is somewhat elastic and may be made of a rayon type strapping which has some rubber woven into it for mild elasticity, however many other choices are available for use in constructing strap 112 which would be suitable. Strap 112 is provided with an aperture (or series of apertures) at each end which is insertable over knob 110 to provide for retention of strap 112 in proper position when nasal dilation assembly 100 is arranged and positioned properly on the user as shown in FIG. 1.

Nasal dilation assembly 100 is arranged and positioned on the head of a user as shown in FIG. 1, and with each of pads 102 arranged and positioned to make contact with the target area 40 of the cheek of the user. Counterintuitively, application of an inwardly directed force at the target area 40 results in indirect dilation of nasal passageways at the nasopharanx internal from the target area 40. An inwardly directed acupressure force at the target area on one side of the face results in dilation of internal nasal passageways on that same side of the face. In one embodiment of the invention, the nasal dilation assembly makes contact with the target area 40 on one cheek side. In another embodiment of the present invention, the nasal dilation assembly makes contact with the target area 40 on both cheek sides to dilate internal nasal passageways on both sides of the user's face.

Many different configurations for spring 104 can be utilized, some of which include a spring designed to fit from under the chin or to fit from behind the head. Alternatively a spring can be integrated into a headphone unit or into almost any helmet design used in sports if such design takes into account safety needs and constructs the pair of pads 102 to be suitably collapsible or displaceable upon hard impact, especially for high contact sports. Nasal dilation assembly 100 can be designed and constructed such that pad 102 can be made to be adjustable at the bottom ends of spring 104, with such adjustment for angle to spring 104, or to the target area, without departing from this novel art. Manufacturing nasal dilation assembly 100 with said adjustments can allow the user to specifically adjust each pad for the desired and best contact and pressure to be applied to the target area.

Nasal dilation assembly 100 can be manufactured in many different configurations to fit the personal preference of different individual users. It can have a spring configured and constructed which will allow it to be placed under the chin, or around the neck in back, or even placed in front of the head, above or below the nose. It can be constructed to contain ear phones for audio, enabling the user to listen to a radio, iPod or cell phone while using the nasal dilation device 100. In addition, a spring 104 can be constructed of a rigid material which holds its approximate form even when worn, and the spring action for asserting pressure against the target area can be supplied by the compressibility of the pad such as pad 102 or a spring system inside or behind it. The pad can be constructed in a larger combination form such as shown in FIG. 15, which will depress the approximate center of the cheek and the cheek area just below the zygomatic bone.

FIG. 1 shows strap 112 arranged and positioned to hold nasal dilation assembly 100 in proper position. The use of pad 106 (shown in FIG. 4) to apply pressure between the user and spring 104, along with strap 112 and the pressure applied bilaterally to each cheek target area by the pair of pads 102, provides sufficient support to keep nasal dilation assembly 100 in position in most situations, including vigorous exercise. An additional strap (not shown) could be affixed to the pair of knobs 110 and arranged and positioned to cross the forehead of the user or even under the nose of the user in order to provide good support.

Of course, if the pair of pads 102 is provided with double sided medical grade adhesive or tape, then even more stability can be provided to nasal dilation assembly 100. If the nasal dilation assembly 100 is carefully fit with suitable pressure applied at pad 106 and suitable pressure applied at the bilateral pair of target areas of the cheeks of the user, then it is possible to construct nasal dilation assembly 100 without use of any strap(s) such as strap 112. Pad 102 itself can be constructed of a compressible foam plastic or rubber like material with rebound memory that can be arranged to exert sufficient and desired depression of the target area if a rigid yoke structure is utilized to provide support for the pair of pads used such as pad 102.

Spring 104 can be shaped to provide some upward force from the horizontal to the target area, less than that applied horizontally to the target area as shown in FIG. 4. In this embodiment an upward angle of about 35 degrees from the horizontal was used to vector the upward force into the target area. Other angles could be used including up to a vertical force, and this capability could be manufactured into the nasal dilation assembly 100 allowing easy adjustment by the user. It was determined by the inventor during experimentation that nasal dilation assembly 100 works somewhat more effectively in some individuals when there is some upward angular force applied to the target area to press snugly against the lower end of the zygomatic bone and the lower side of the lower lateral pterygoid process bone while exerting slight inward pressure against the upper portion of the maxilla bone. These pressures should be sufficient to depress the target area of the cheek suitably, and also for optimal effectiveness can have some of the force applied at an upward inward angle from the horizontal, which can provide more enhancement of breathing in some, all without abrading, bruising or harming the inner side of the cheek, the gums or the teeth.

Spring 104 is strong enough to assert adequate pressure to each of the bilaterally positioned pads 102 to keep the target area suitably and adequately depressed without abrading, bruising or harming the array of upper teeth, gums or inner cheek. In one embodiment, a force of approximately 1.20 lbs was applied through each pad 102. However individual needs can vary and adjustments can be designed, manufactured and incorporated into the finished product which will allow pressure to be adjusted to an increase or to a decrease within a fairly broad range, generally within 0.5 lb to 3 lbs, but individual cases could require less or more. Pad 106 can also be supplied in different thicknesses and hardnesses, if suitable means for adjusting length are not provided to nasal dilation assembly 100. In addition telescoping means can be provided to the top of spring 104 to increase or decrease the pressure applied to each of the pair of pads 102.

Nasal dilation assembly 100 is designed as a freestanding unit which can be used alone or with many mask assemblies for PAP usage. Nasal dilation assembly 100 can be used alone to enhance breathing and respiration during exercise or sports, or anytime based on the personal preference of the user. It may also be helpful for some who play exhalation powered musical instruments by enhancing exhalation when it is used with the small pad shown in FIG. 1, which depresses the area of the cheek under the zygomatic bone.

When nasal dilation assembly is properly arranged and positioned such that the pair of pads 102 are suitably depressing the target area bilaterally on the cheeks and strap 112 is properly arranged and positioned to retain nasal dilation assembly 100 in proper position, breathing and respiration can be enhanced. The suitable and effective depression of the target area of the user's cheek enhances respiration in a significant number of individuals perhaps by neurological or neuromuscular stimulation means. FIG. 1 shows how nasal dilation assembly 100 appears when properly arranged and positioned whereby the pair of pads 102 are positioned to suitably depress the target area of the cheek. For maximum effectiveness in enhancing breathing and respiration, pressure must be applied to the target area in a sustained and focused fashion, but even minimal pressures appear to enhance breathing and respiration somewhat in a significant number of individuals.

A sustained and significant pressure to the target area appears to directly enhance inhalation as well as exhalation somewhat, even without depressing the approximate center of the cheek. And in addition, it was determined that if some pressure was applied to the target area in an upward angle from the horizontal, there was an additional enhancement of breathing in some individuals. Nasal dilation assembly 100, when properly arranged and positioned, may enhance breathing and respiration during normal sleeping in some individuals.

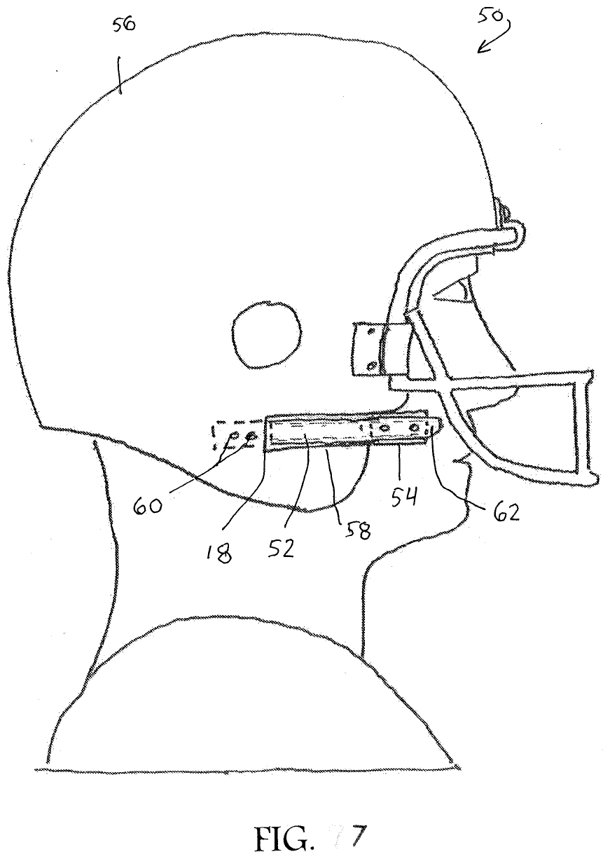

FIG. 6 is a side view illustration of an embodiment of the present invention. A sports helmet assembly 10 includes a shell 12, spring 14 and a check-engaging pad assembly 16 which is attached to spring 14. Helmet assembly 10 includes a padded shell of traditional construction. Spring 14 at one end passes through an aperture 18 of shell 12 and is then fastened to the inside of shell 12. A portion of spring 14 rests in a surface channel 20 in shell 12. As described herein, pad assembly 16 defines a cheek depressing device. Spring 14 is held onto shell 12 via fasteners 22, such as rivets, etc.

In order to put on or remove football helmet assembly 10, the user must pull springs 14 apart to move pad assembly 16 outward away from shell 12, after which the springs 14 can be slowly released once the helmet is donned. During hard shocks spring 14 will be able to flex somewhat thereby adjusting to the exact temporary position of the users face and head inside football helmet assembly 10. The simultaneous depression of the target area and the approximate center of each cheek can provide enhanced breathing.

FIG. 7 depicts another embodiment of the present invention. A football helmet assembly 50 includes a bilateral and integral cheek depressor comprised of a spring 52 and pad 54. Football helmet assembly 50 is comprised of a generally rigid shell 56 having a padded interior. Shell 56 is provided an aperture 18 through which spring 52 passes into and through. Shell 56 is also provided with a surface channel 58 deep enough to retain spring 52 at or beneath the outside surface of shell 56 when it is properly installed and in proper operating position after football helmet assembly 50 is in proper wearing position.

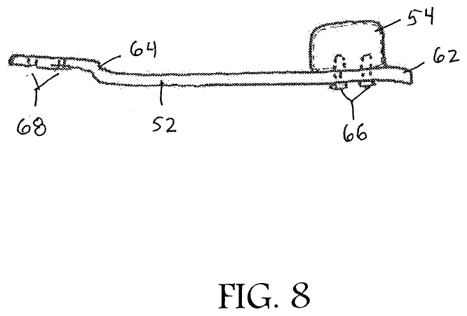

FIG. 8 shows spring 52 as being bent to allow it to be inserted through aperture 18 and to then engage against surface channel 58 after it has been secured in place, via for example a pair of rivets 60. Spring 52 is provided with a tab 62 at one end which allows the user to grasp spring 52 and pull it and its attached pad 54 away from shell 56 in order to either put on or remove football helmet assembly 50.

Spring 52 is provided with a pad 54 which is substantially firm and is molded, such as with a medical grade silicone compound. Pad 54 has a slight convex shape to its inner surface which faces the user. FIG. 8 shows spring 52 to have a double opposing bend 64 provided for spring 52 to fit properly into and through aperture 18. If the user desires a slightly upward force applied to the target area, a slight twist can be added to spring 52. A plurality of fasteners 66 are used to connect spring 52 to pad 54. Spring 52 includes a plurality of apertures 68 through which fasteners 60 are received during installation.

Football helmet assembly 50 of FIG. 7 provides an integral cheek depressor allowing a football player to enhance his breathing while playing football. During hard shocks spring 52 will be able to flex somewhat thereby adjusting to the exact momentary positional change of the user's face and head inside football helmet assembly 50. Some players might prefer a pad 54 that extends downward farther toward the approximate center of the cheek below the target area in addition to a pronounced depression of the target area.

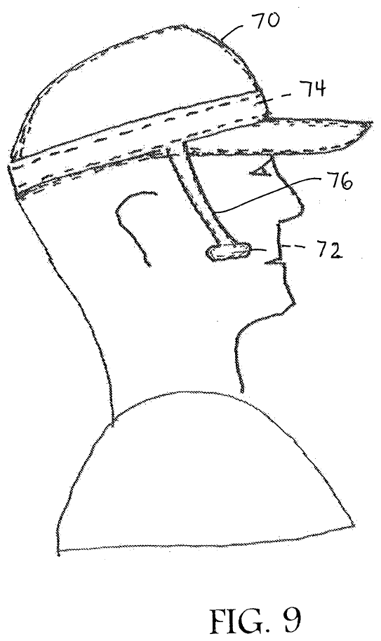

FIG. 9 shows user another embodiment of the present invention including a cap assembly 70 including pads 72 held tightly in place against the target area of the cheek via spring frame 74 and spring leg 76. Cap assembly 70 may be a baseball-style cap.

Spring frame 74 and spring leg 76 in this embodiment are constructed of a spring material, such as stainless steel, which will hold its shape and exert generally constant pressure inwardly thereby directing forces into the target area of the user. Portions of cap assembly 70 may be constructed of fabric, such as a heavy duty cotton/polyester weave. The pair of spring legs 76 have pads 72 affixed to each end. Pads may be constructed of molded medical grade silicone. The inner surface (facing user) of pads 72 is somewhat rounded or convex. Spring leg 76 can be curved inward at its lower section in such a way that pad 72 can be arranged and positioned to provide a somewhat angular upward force against the target area of the cheek in addition to an approximately horizontal force applied inward against the target region. In some users a slight upward angle to the force applied provides somewhat better breathing than a straight horizontally applied force. Double sided medical grade tape tabs can be constructed of the proper size and applied to the cheek side surface of pads 72 to help keep pads 72 in proper position during vigorous exercise.

Stainless steel alloy for the spring frame 74 is a reasonable choice for compactness, durability and rebound memory and is selected for this embodiment, but many other materials could be used to construct spring frame 74 and spring leg 76 including other types of metals, plastics or composites providing higher strength, better rebound memory and light weight. Spring frame 74 is preferably constructed of a spring type material with good rebound memory, but it is also possible to construct frame 74 of a mostly rigid material and provide compressible pads with rebound memory instead. Spring legs 76 may be provided with a telescoping adjustment means.

In order to don cap assembly 70, a user spreads apart the spring legs 76, places the cap in proper wearing position, and then releases the pair of spring legs 76, allowing the pair of pads 72 to move inwardly to press snuggly and depress into the target area of each cheek. Legs 76 can be adjusted by increasing or decreasing their length by use of the telescoping feature built into each leg 76 (not shown but understood in the art) if needed for good contact between the pad 72 and the target area of the cheek. A double-sided medical grade tape tab can be applied to the inner surface of each of the pair of pads 72, which in addition to the tension provided by spring leg 76 will help keep pad 72 in proper position during hard or jarring exercise and will help keep the cap in place. The double-sided tape tabs are disposable and can be replaced at each use of the hat or as frequently as desired by the user.

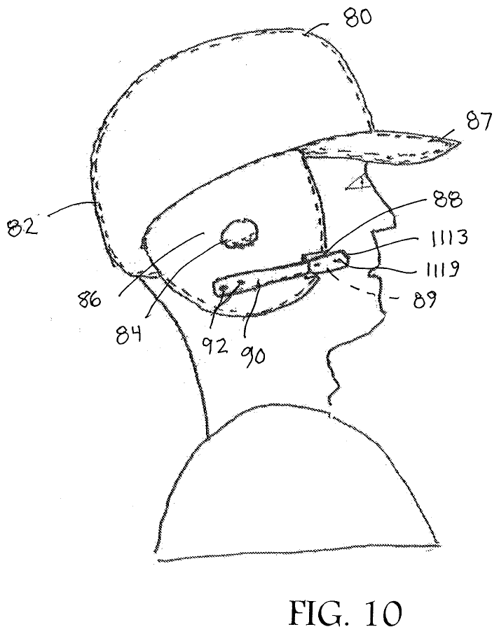

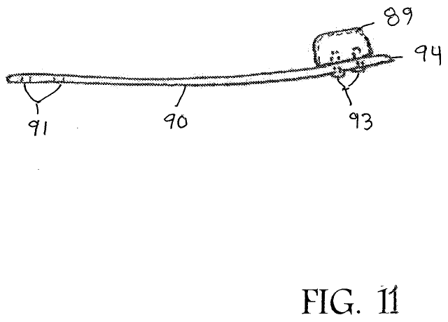

FIG. 10 depicts another embodiment of the invention. A batting helmet assembly 80 is a protective helmet used by baseball players. Batting helmet assembly 80 has a shell 82 which contains an inner padding (not shown) which helps cushion and protect the head from shock when hit by a baseball. An aperture 84 is provided to ear protector cavity 86 to allow the wearer to hear. Batting helmet assembly 80 is typically constructed of a strong resilient type of molded plastic or fiberglass, but carbon fiber can be selected for molding as an even stronger, lighter option. Batting helmet assembly 80 is provided with a visor 87 and a cutaway 88, which is a small cutaway from the bottom front of ear protector cavity 86. Cutaway 88 provides clearance for the penetration of a pad 89 through ear protector cavity 86 to make good contact with the target area of the cheek of the user.

Ear protector cavity 86 is provided with a spring 90 to which pad 89 is provided to its inward facing side toward the user's face. Pad 89 is molded of medical grade silicone which can feel sticky to the touch when cleaned with soapy water. Pad 89 is somewhat convex at its inner side which faces the cheek and has no sharp edges. Spring 90 is comprised in this instance of a high-quality stainless steel which provides good strength and rebound memory while providing adequate force against pad 89 to depress the target area of the cheek of the user.

As shown in FIG. 11, spring 90 is provided with apertures 91 at each end. These end apertures 91 are used to attach spring 90 to ear protector cavity 86 via, for example, rivets 92 passing through holes provided to shell 82 (not shown). Threaded fasteners 93 are used to secured pad 89 to spring 90. Other types of fasteners and even glue pads or glue can also be used to affix pad 89 to spring 90. Pad 89 can be provided in different widths in order to provide for individual differences in facial anatomy, thereby insuring proper tension to spring 90 which will in turn provide proper depression of the target area of the cheek. Tab 94 is provided at one end of spring 90 to provide a point for the user to grab and manipulate pad 89 away from the target area of the cheek, so that the helmet can be put on or removed.

As shown in FIG. 10, batting helmet assembly 80 positions pad 89 against the target area 40 of the cheek via spring 90. The integral use of a cheek depressor to a batting helmet assembly 80 allows enhanced breathing for the batter. Batting helmet assembly 80 can be donned or removed by grasping tabs 94 and pulling each spring 90 outward to thereby pull each pad 89 away from the cheek of the user.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, and methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method dilating nasal tissue of the normally inaccessible nasopharynx by application of acupressure at a remote facial acupressure site, said method comprising:
providing a pad at a cheek acupressure point located between a jawbone and a zygomatic bone of a user;
pressing against said pad at the cheek acupressure point with a head-worn spring, with said spring applying an inward spring force through the pad to the acupressure point; and
dilating nasal passageways of the nasopharynx by application of said inward spring force to said pad.

2. (canceled)

3. The method of claim 1 further comprising placing an adhesive layer between the pad and the cheek acupressure point for securing the pad in place.

4. The method of claim 1 wherein the pad is gas-filled.

5. The method of claim 1 wherein the inward spring force applied through the pad to the acupressure point ranges from about 0.5 pounds-force to 1.0 pounds-force.

6. The method of claim 1 further comprising pressing with an upward spring force, Fz, in addition to the inward spring force through the pad to the acupressure point.

7. A method for applying facial acupressure using a head-worn spring and a pair of pads connected at ends of the spring, said method comprising the steps of:
the user choosing acupressure points on said user's face located between a jawbone and zygomatic bones on either side of the face;
the user grasping the acupressure apparatus by the spring and applying an opening force to outwardly bias the spring to allow the pads to pass over a portion of the user's head;
the user positioning said acupressure apparatus on the user's face until the pads are at the acupressure points; and
the user releasing the opening force to allow said pads to engage the acupressure points and to apply spring forces to the acupressure point using the said acupressure apparatus.

8. (canceled)

9. The method of claim 7 further comprising placing an adhesive layer between the pads and the acupressure points for securing the pads in place.

10. The method of claim 7 wherein the pads are gas-filled.

11. The method of claim 7 wherein the inward spring force applied through the pads to the acupressure points ranges from about 0.5 pounds-force to 1.0 pounds-force.

12. The method of claim 7 further comprising an upward spring force, Fz, in addition to the inward spring force through the pads to the acupressure points.

13. An apparatus for applying acupressure to targeted pressure points on a human user's face, the apparatus comprising:
a head-worn, generally C-shaped spring with an opening being expandable by the human user; and
a pair of pads attached at ends of the spring, with the pair of pads being positioned by the human user to engage cheek acupressure points located between a jawbone and zygomatic bone of the human user, and with the spring pressing the pair of pads inwardly at the cheek acupressure points so as to indirectly dilate nasal passageways of the nasopharanx of said human user.

14. (canceled)

15. The apparatus of claim 13 further comprising an adhesive layer between the pads and the acupressure points for securing the pads in place.

16. The apparatus of claim 13 wherein the pads are gas-filled.

17. The apparatus of claim 13 wherein the inward spring force applied through the pads to the acupressure points ranges from about 0.5 pounds-force to 1.0 pounds-force.

18. The apparatus of claim 13 further comprising an upward spring force in addition to the inward spring force through the pads to the acupressure points.

19. The apparatus of claim 13 further comprising an elastic strap attached to the spring and adapted to engage around the user's head.

20. The apparatus of claim 19 wherein the elastic strap is secured to the spring near the pads.
